(19) United States
(12) Patent Application Publication
(10) Pub. No.: US 2026/0249849 A1
(43) Pub. Date: Aug. 27, 2026

(54) Method and Device for Controlling the Coasting Mode of a Motor Vehicle While Taking Into Consideration an Object on the Adjacent Lane

(71) Applicant: Bayerische Motoren Werke Aktiengesellschaft, Muenchen (DE)

(72) Inventors: Helena DOLINAJ, Muenchen (DE); Miguel LOENNE, Muenchen (DE); Sebastien MATHIEU, Fuerstenfeldbruck (DE)

(21) Appl. No.: 18/861,238

(22) PCT Filed: Apr. 20, 2023
(86) PCT No.: PCT/EP2023/060332

§ 371 Date: Oct. 29, 2024

(30) Foreign Application Priority Data
May 6, 2022 (DE) 10 2022 111 310.8

(51) Int. Cl. B60W 30/18; B60W 30/16; B60W 50/00

(52) U.S. Cl. CPC B60W 30/18072; B60W 30/16; B60W 30/18154; B60W 50/0097; B60W 2552/15; B60W 2554/802

(57) ABSTRACT

A device for controlling the coasting mode of a vehicle in the context of a distance control and/or speed control function of the vehicle is provided. The device is designed to predict a distance curve of the vehicle in the coasting mode on the basis of the current travel progress of the vehicle and to compare the predicted distance curve of the vehicle with a target distance of the distance control and/or speed control function of the vehicle. In the process, the predicted distance curve indicates the chronological and/or spatial distance of the vehicle to an object traveling in front of the vehicle on an adjacent lane as a function of the travel progress. The device is also designed to control the coasting mode on the basis of the comparison.

### BACKGROUND AND SUMMARY

The invention relates to a motor vehicle designed to be operated in a coasting mode. In particular, the invention relates to a method and a corresponding device for controlling the coasting mode of a motor vehicle.

A vehicle having an internal combustion engine can be designed to temporarily decouple the internal combustion engine from the drivetrain of the vehicle during a journey and possibly deactivate it to reduce the energy consumption of the vehicle. In other words, the vehicle can be designed to be temporarily operated in the coasting mode during a journey.

The present document relates to the technical object of enabling a particularly energy-efficient, safe, and/or comfortable coasting mode of a vehicle, in particular in conjunction with a distance and/or speed control of the vehicle.

The object is achieved by each of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description which can form an invention independent of the features of the independent claims.

According to one aspect, a (control) device for controlling the coasting mode of a (motor) vehicle in the context of a distance and/or speed control of the vehicle is described. During the operation of the distance and/or speed control, the driving speed can be adapted automatically in dependence on a target distance (defined by the driver) to the preceding vehicle driving (directly) in front of the vehicle or to an adjacent lane object (in particular an adjacent lane vehicle) driving on an adjacent lane (i.e., on a neighboring lane) and/or (during an open-road journey) in dependence on a target speed (defined by the driver), in particular controlled (to the target distance and/or to the target speed).

The vehicle can drive on an ego lane and the adjacent lane or the neighboring lane can be arranged directly or indirectly adjacent to the ego lane. Therefore, there can possibly be no other lanes arranged between the ego lane and the adjacent lane. Alternatively, one or more further lanes can be arranged between the ego lane and the adjacent lane. The adjacent lane can be arranged on the left adjacent to the ego lane if overtaking on the right is forbidden and/or can be arranged on the right adjacent to the ego lane if overtaking on the left is forbidden.

The device can be configured to decouple the drive motor (in particular the internal combustion engine) of the vehicle from the drivetrain of the vehicle (and possibly to deactivate the drive motor) in order to start the coasting mode. Alternatively or additionally, the device can be configured to couple the drive motor with the drivetrain of the vehicle (and possibly to activate the drive motor) in order to end the coasting mode. The vehicle can roll in the coasting mode without action of a drive torque and/or a drag torque of the drive motor.

During the coasting mode of the vehicle, typically no drive torque and/or drag torque is therefore caused by the drive motor of the vehicle. No braking torque (due to one or more friction brakes of the vehicle) can possibly also be effectuated during the coasting mode. Therefore, possibly no active distance and/or speed control can take place during the coasting mode. However, it can be monitored in this case that during the coasting mode the distance of the vehicle to the preceding vehicle (on the ego lane) and/or to an adjacent lane object (on an adjacent lane) remains within a predefined tolerance band around the target distance and/or that the driving speed of the vehicle remains within a predefined tolerance band around the target speed. An active distance and/or speed control (to the target distance or to the target speed) can take place outside the coasting mode. In particular, in this case it is possible to cause the distance and/or the driving speed to be set to the target distance or to the target speed directly after ending the coasting mode.

The device is configured to predict a distance profile of the vehicle in the coasting mode proceeding from a current driving progression of the vehicle (for example, proceeding from the current time and/or proceeding from the current position). The predicted distance profile can indicate the temporal and/or spatial distance of the vehicle to the preceding vehicle driving (directly) in front of the vehicle or to the adjacent lane object (driving on the adjacent lane (directly) in front of the vehicle) as a function of the driving progression (proceeding from the current driving progression). The predicted distance profile can extend here proceeding from the current driving progression over a predefined prediction horizon.

The driving progression can indicate the position of the vehicle along the roadway traveled by the vehicle or correspond thereto. Alternatively or additionally, the driving progression can indicate the respective time during the journey of the vehicle or correspond thereto. The prediction horizon can therefore correspond to a specific distance and/or time horizon (e.g., 100 m or more, or 500 m or more; or 10 seconds or more, or 20 seconds or more).

The device can be configured to ascertain an upcoming gradient profile of the roadway traveled by the vehicle (for the prediction horizon). This information can be ascertained on the basis of a digital map for the roadway network traveled by the vehicle. The distance profile of the vehicle in the coasting mode can then be predicted in a precise manner on the basis of the upcoming gradient profile.

The device can furthermore be configured to ascertain status data with respect to the status (for example, the current driving speed) of the vehicle and/or with respect to the status (for example, the current driving speed) of the adjacent lane object driving in front of the vehicle on the adjacent lane. The distance profile of the vehicle in the coasting mode can then be predicted in a particularly precise manner on the basis of the status data.

Upon the prediction of the distance profile of the vehicle, it can be assumed that the vehicle is in the coasting mode during the entire prediction horizon. Furthermore, an assumption with respect to the behavior of the preceding vehicle and/or the adjacent lane object during the prediction horizon can be made. For example, it can be assumed that the driving speed of the preceding vehicle and/or the adjacent lane object remains constant during the entire prediction horizon.

The device is furthermore configured to compare the predicted distance profile of the vehicle to the target distance of the distance and/or speed control of the vehicle. What can be ascertained here in the context of the comparison are, for example, the driving progression section in which the predicted distance profile remains within the predefined tolerance band around the target distance; and/or the driving progression at which the predicted distance profile reaches the target distance (and possibly subsequently falls below or exceeds it).

The coasting mode can then be controlled in dependence on the comparison (in particular in dependence on the ascertain driving progression section and/or in dependence on the ascertained driving progression), in particular can be started or ended. A particularly energy-efficient, comfortable, and/or safe coasting mode of a vehicle having active distance and/or speed control can thus be effectuated. During the distance and/or speed control and/or during the coasting mode, it is possible to deviate here at least temporarily and/or within the specific tolerance band from the target distance and/or from the target speed. The tolerance band can be, for example, ±5% or less or ±10% or less of the target distance or the target speed.

The device can be configured to ascertain, in particular while the vehicle is not operated in the coasting mode (and with active distance and/or speed control), whether the predicted distance profile of the vehicle will reach the target distance at an upcoming driving progression or not. The coasting mode can be started (selectively), for example, at the current driving progression of the vehicle, in particular can possibly only be started when it is ascertained that the predicted distance profile of the vehicle will reach the target distance. A particularly energy-efficient and/or comfortable entry into the coasting mode can thus be enabled.

The device can be configured, in particular while the vehicle is operated in the coasting mode (and possibly no active distance and/or speed control takes place), to ascertain an upcoming intersection driving progression at which the predicted distance profile of the vehicle will reach the target distance. An exit driving progression can then be ascertained in dependence on the ascertained upcoming intersection driving progression. The device can be configured here to ascertain an exit driving progression which lies before the ascertained upcoming intersection driving progression, in particular by a predefined offset value before the ascertained upcoming intersection driving progression. The offset value can be, for example, 10 m or less (for example, between 5 and 10 m), or 2 seconds or less (for example, between 1 and 2 seconds). The coasting mode can then be ended at the ascertained exit driving progression (and the distance and/or speed control can be automatically activated). A particularly comfortable and energy-efficient exit from the coasting mode (without subsequent acceleration by the drive motor of the vehicle) can thus be effectuated in order for the vehicle to have the target distance (to the preceding vehicle on the ego lane or to the adjacent lane object on the adjacent lane) after ending the coasting mode.

The device can be configured, in particular while the vehicle is not operated in the coasting mode (and while a distance control to a preceding vehicle and/or to an adjacent lane object takes place), to predict the distance profile of the distance of the vehicle to the adjacent lane object driving on the adjacent lane during the coasting mode. Furthermore, it can be ascertained whether the predicted distance profile falls below the target distance by precisely or at least a predefined penetration depth (for example, between 5% and 10%) or not. The coasting mode can be started (at the current driving progression), in particular can possibly only be started if it is ascertained that the predicted distance profile falls below the target distance by precisely or at least the predefined penetration depth. A particularly energy-efficient and/or comfortable subsequent exit from the coasting mode can thus be enabled.

The device can be configured, in particular while the vehicle is operated in the coasting mode (and a distance control takes place after exit from the coasting mode), to predict the distance profile of the distance of the vehicle to the adjacent lane object driving in front of the vehicle on the adjacent lane during the coasting mode. The upcoming driving progression can then be ascertained at which the predicted distance profile of the vehicle will reach the target distance (for the first time). The coasting mode can then be ended in a particularly energy-efficient and comfortable manner at an exit driving progression, which is dependent on the ascertained upcoming driving progression.

The device can be configured to carry out the measures described in this document repeatedly at a sequence of successive driving progressions (in particular times and/or positions). The device can be configured to predict a distance profile of the vehicle in the coasting mode proceeding from the respective current driving progression. The device can furthermore be configured to compare the respective predicted distance profile of the vehicle to the target distance of the distance and/or speed control of the vehicle. In addition, the device can be configured to control, in particular start or end, the coasting mode at the respective current driving progression in dependence on the comparison. A continuously more energy-efficient and/or comfortable coasting mode can thus be effectuated with active distance and/or speed control.

According to a further aspect, a (road) motor vehicle (in particular a passenger vehicle or a truck or a bus or a motorcycle) is described which comprises the (control) device described in this document.

According to a further aspect, a method for controlling the coasting mode of a vehicle in the context of an (active) distance and/or speed control of the vehicle is described. The coasting mode can be embedded in a distance and/or speed control here. The active distance and/or speed control can take place automatically when the vehicle is not operated in the coasting mode. The coasting mode can be limited such that during the coasting mode the target distance is not fallen below and/or the distance of the vehicle to a preceding vehicle or to an adjacent lane object remains within a specific tolerance band and/or the target speed remains within a specific tolerance band.

The method comprises predicting, proceeding from a current driving progression of the vehicle, a distance profile of the vehicle in the (sole and/or continuous) coasting mode. The predicted distance profile can indicate the temporal and/or spatial distance of the vehicle to an adjacent lane object driving in front of the vehicle on a neighboring lane (i.e. on an adjacent lane) as a function of the driving progression.

The method furthermore comprises comparing the predicted distance profile of the vehicle to the target distance (defined by the driver) of the distance and/or speed control of the vehicle. The method additionally comprises controlling, in particular starting or ending, the coasting mode in dependence on the comparison.

According to a further aspect, a software (SW) program is described. The SW program can be configured to be executed on a processor (for example on a control unit of a vehicle) and to thus carry out the method described in this document.

According to a further aspect, a storage medium is described. The storage medium can comprise an SW program which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth between parentheses are to be understood as optional features.

The invention will be described in more detail hereinafter on the basis of exemplary embodiments. In the figures

### BRIEF DESCRIPTION OF THE DRAWINGS

FIG. 1 shows exemplary components of a vehicle;

FIG. 2a shows an exemplary driving situation of a vehicle;

FIG. 2b shows an exemplary gradient profile of a roadway;

FIG. 2c shows an exemplary driving situation having an adjacent lane object;

FIG. 3a shows exemplary predicted distance profiles during the coasting mode;

FIG. 3b shows an exemplary exit driving progression for ending the coasting mode; and

FIG. 4 shows a flow chart of an exemplary method for controlling the coasting mode of a vehicle.

### DETAILED DESCRIPTION OF THE DRAWINGS

As described at the outset, the present document relates to increasing the energy efficiency and/or the comfort and/or the safety of the coasting mode of a motor vehicle. In this context, FIG. 1 shows an exemplary vehicle 100. The vehicle 100 comprises one or more surroundings sensors 102 (e.g., at least one camera, a radar sensor, a lidar sensor, and/or an ultrasonic sensor), which are configured to acquire surroundings data (i.e., sensor data) with respect to the surroundings of the vehicle 100. Furthermore, the vehicle 100 comprises one or more vehicle sensors 106, which are configured to acquire status data (i.e., sensor data) with respect to a status (for example, with respect to the driving speed) of the vehicle 100.

A (control) device 101 of the vehicle 100 can be configured to operate the drive motor 103 (in particular the internal combustion engine) of the vehicle 100 in dependence on the surroundings data and/or the status data in order to longitudinally guide the vehicle 100 in an at least partially automated manner. In particular an automatic distance and/or speed control (in particular ACC, adaptive cruise control) can be effectuated here, in which the driving speed of the vehicle 100 is adjusted automatically in order to adjust the distance of the vehicle 100 to a preceding vehicle driving directly in front of the vehicle 100 and/or to an adjacent lane object to a target distance (which was defined by the driver of the vehicle 100, for example) and/or to adjust the driving speed of the vehicle 100 during an open-road journey (without preceding vehicle and/or without adjacent lane object) to a target speed (which was defined by the driver of the vehicle 100, for example).

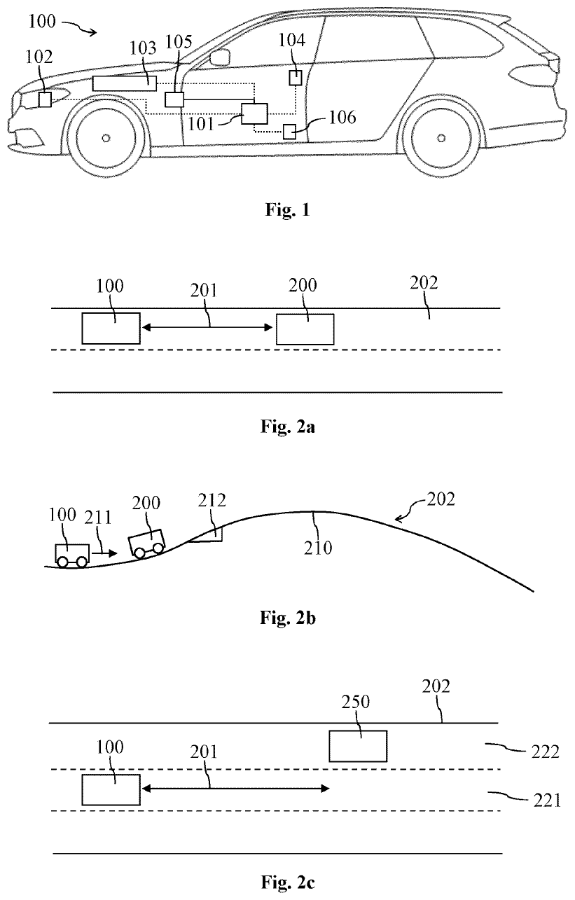

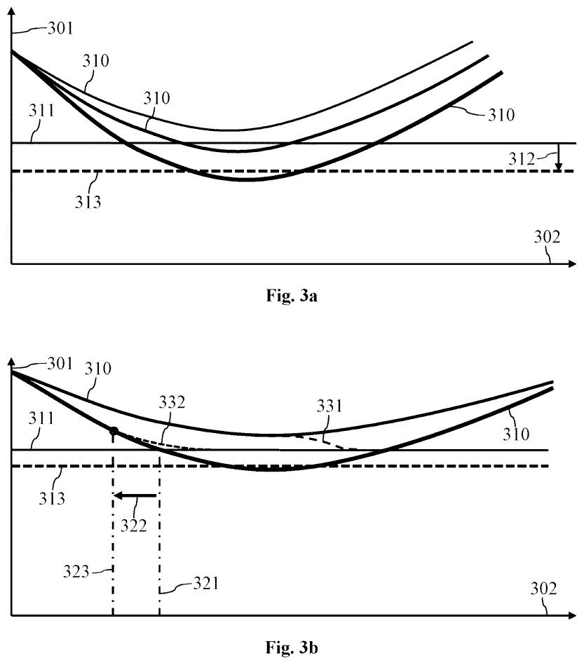

FIG. 2a shows an exemplary driving situation in which the vehicle 100 drives on a roadway 202 behind a preceding vehicle 200. The distance 201 between the vehicle 100 and the preceding vehicle 200 is set by the device 101 of the vehicle 100 to a specific target distance. The distance 201 can be a spatial distance here, which corresponds to the spatial distance (for example, measured in meters) between the vehicle 100 and the preceding vehicle 200. Alternatively or additionally, the distance 201 can be a temporal distance, which corresponds to the time the vehicle 100 would require at the current driving speed in order to reach the preceding vehicle 200 (under the assumption that the preceding vehicle 200 is stationary). The temporal distance can correspond, for example, to the quotient of the current driving speed of the vehicle 100 and the spatial distance between the vehicle 100 and the preceding vehicle 200. The distance 201 to an adjacent lane object on a neighboring lane can be viewed in a corresponding manner (as shown by way of example in FIG. 2c).

The (control) device 101 can be configured to operate the vehicle 100 at least temporarily in a so-called coasting mode during an active distance and/or speed control. For this purpose, the coupling 105 of the vehicle 100 can be prompted to decouple the drive motor 103 from the drivetrain of the vehicle 100, in particular from the one or more driven wheels of the vehicle 100. Furthermore, a deactivation and/or a setting aside of the drive motor 103 can be effectuated. The vehicle 100 then rolls (without drag torque and/or without drive torque of the drive motor 103) over the roadway 202 traveled by the vehicle 100. The energy consumption of the vehicle 100 can thus be reduced.

The vehicle 100 can comprise a position sensor 104 which is configured to acquire position data (i.e., sensor data) with respect to the respective current position of the vehicle 100. The position data can comprise, for example, coordinates of a global navigation satellite system (GNSS), such as GPS coordinates. The device 101 can be configured to ascertain the spatial profile of the roadway 202, on which the vehicle 100 is being driven, on the basis of the position data and on the basis of a digital map with respect to the roadway network traveled by the vehicle 100. A driving route through the roadway network can optionally have been planned by means of a navigation system of the vehicle 100. It can be recognized on the basis of the driving route along which roadway 202 the vehicle 100 will be driven proceeding from the current time and/or proceeding from the current position. Furthermore, the spatial profile, in particular the gradient profile, of the upcoming roadway 202 can be ascertained on the basis of the digital map.

FIG. 2b shows an exemplary gradient profile 210 of the roadway 202 traveled by the vehicle 100. The gradient profile 210 indicates the gradient 212 of the roadway 202 as a function of the position on the roadway 202 and/or as a function of the time during a journey.

The device 101 can be configured to predict a distance profile and/or a speed profile of the vehicle 100 in the coasting mode on the basis of the gradient profile 210 of the upcoming roadway 202. The distance profile can indicate the (temporal and/or spatial) distance 201 of the vehicle 100 to the preceding vehicle 200 (or to an adjacent lane object on a neighboring lane), as a function of the position and/or as a function of the time. The speed profile can indicate the driving speed of the vehicle 100 as a function of the position and/or as a function of the time. It can be assumed here that the vehicle 100 is operated in the coasting mode (without action of a drive, drag, and/or braking torque generated by the vehicle 100). Furthermore, (to ascertain the distance profile), a specific speed behavior of the preceding vehicle 200 and/or of the adjacent lane object can be assumed; for example, it can be assumed that the preceding vehicle 200 and/or the adjacent lane object are driven at a constant driving speed. The distance profile and/or the speed profile can be predicted, for example, for a spatial prediction horizon of 50 m or more, or of 100 m or more (proceeding from the current position of the vehicle 100) and/or for a temporal prediction horizon of 5 seconds or more, or of 10 seconds or more.

The activation (also referred to as the entry) and/or the deactivation (also referred to as the exit) of the coasting mode of the vehicle 100 can then be carried out in a precise and energy-efficient manner (during use of the distance and/or speed control) in dependence on the predicted distance profile and/or in dependence on the predicted speed profile. In particular, the device 101 of the vehicle 100 can be configured (during the operation of the distance and/or speed control) to predict a distance profile and/or a speed profile of the vehicle 100 in the coasting mode proceeding from the current position of the vehicle 100 and/or proceeding from the current time. An entry into or an exit out of the coasting mode can then be effectuated in dependence on the predicted distance profile and/or speed profile.

It can possibly be necessary for the driving operation of the vehicle 100 to take into consideration an object, in particular another vehicle, on an adjacent lane to the ego lane of the vehicle 100. The adjacent lane can be a lane in this case which is arranged adjacent to the ego lane traveled by the vehicle 100. FIG. 2c shows the vehicle 100, which drives on a first or ego lane 221 of the roadway 202. Furthermore, FIG. 2c shows an adjacent lane object 250, in particular a vehicle, which drives on a second lane 222 of the roadway 202, wherein the second lane 222 is arranged directly adjacent to the first or ego lane 221. It can be necessary, for example, due to a “ban on overtaking on the right” for the adjacent lane object 250 (driving on the adjacent lane 222 in front of the vehicle 100) to also be taken into consideration in the context of the distance and/or speed control of the vehicle 100. In this case, in particular the actual distance 201 between the vehicle 100 and the adjacent lane object 250 can be taken into consideration, and possibly adjusted, in particular controlled, to a specific target distance in the context of the distance and/or speed control of the vehicle 100.

The (control) device 101 of the vehicle 100 can be configured to take into consideration an adjacent lane object 250 driving in front of the vehicle 100 on an adjacent lane 222 also during a coasting mode of the vehicle 100.

FIGS. 3a and 3b show exemplary predicted distance profiles 310, wherein a distance profile 310 indicates the (temporal or spatial) distance 301 as a function of the driving progression 302 (for example, as a function of the time or as a function of the position on the upcoming roadway 202) of the vehicle 100 proceeding from the current time or proceeding from the current position. The distance 301 can be the distance 201 between the vehicle 100 and the adjacent lane object 250 driving in front of the vehicle 100 on the adjacent lane 222.

The device 101 can be configured to predict a distance profile 310 before entry into the coasting mode (during the operation of the distance and/or speed control). It can be assumed here that the vehicle 100 is in the coasting mode during the entire prediction horizon. The predicted distance profile 310 can be compared to the target distance 311 for the distance controller. In particular, it can be ascertained here whether the predicted distance profile 310 lies at least partially below the target distance 311. For example, a specific penetration depth 312 can be defined by which the distance can or is permitted to fall below the target distance 311. A limiting distance 313 reduced by the penetration depth 312 in relation to the target distance 311 can then be ascertained. The device 101 can be configured to determine whether the predicted distance profile 310 falls below the limiting distance 313 for a specific section of the driving progression 302 (i.e., for a specific time section or for a specific position section). This is the case in FIG. 3a, for example, for the predicted distance profile 310 having the thickest stroke, while this is not the case for the two other distance profiles 310.

When it is recognized that the predicted distance profile 310 falls on and/or below the limiting distance 313, an entry into the coasting mode can thus be effectuated. On the other hand, if it is recognized that the predicted distance profile 310 does not fall on and/or below the limiting distance 313, an entry into the coasting mode can be suppressed. A particularly energy-efficient and comfortable coasting mode can thus be enabled, in particular because upon the subsequent exit from the coasting mode, a post-acceleration of the vehicle 100 by the drive motor 103 (to adjust the distance 301 between the vehicle 100 and the adjacent lane object 250 to the target distance 311) can be avoided.

During the coasting mode, updated predicted distance profiles 310 can be ascertained repeatedly, in particular periodically, in each case proceeding from the current time and/or proceeding from the current position. As shown by way of example in FIG. 3b, based on the respective predicted distance profile 310, an upcoming intersection driving progression 321 (for example, an upcoming time and/or an upcoming position) can be predicted, at which the predicted distance profile 310 intersects (for the first time) the target distance 311. Based on the predicted intersection driving progression 321, the exit driving progression 323 can then be ascertained, at which the exit from the coasting mode takes place. The exit driving progression 323 can in this case be a specific offset value 322 (for example, of 10 m or more or of 1 second or more) before the predicted intersection driving progression 321.

Due to the defined exit from the coasting mode before reaching the target distance 311, it can be effectuated that the vehicle 100 can be decelerated in a comfortable and energy-efficient manner (for example, by the drag torque of the drive motor 103), in order to adjust the distance 201, 301 of the vehicle 100 to the adjacent lane object 250 to the target distance 311 and in order to pass over into an active control of the distance 201, 301. This is shown by way of example in FIG. 3b by the distance profile 332.

FIG. 3b furthermore illustrates a situation in which the predicted distance profile 310 does not intersect the target distance 311. In this case, the exit from the coasting mode can take place at a driving progression 302 at which the distance profile 310 is relatively close (in particular closest) to the target distance 311. In this case, however, post-acceleration of the vehicle 100 upon reactivation of the distance control is typically necessary (see distance profile 331), which results in an increased energy consumption and a reduced level of comfort.

An assessment of the situation for deactivating the internal combustion engine 103 and for ending the coasting situation can therefore take place, in particular to prevent a post-acceleration to establish the target distance 311 to the adjacent lane object 250. For this purpose, a predicted profile 310 of the temporal distance 301 to the adjacent lane object 250 can be ascertained on the basis of a gradient forecast 210 and/or on the basis of one or more vehicle parameters (such as the driving speed of the vehicle 100 and/or of the adjacent lane object 250) and/or on the basis of the driving situation.

The coasting entry can possibly only be effectuated from a specific plunging depth 312 of the predicted coasting profile 310 (i.e., plunging below the target temporal distance 311 to the adjacent lane object 250). This criterion enables unstable driving situations to be balanced out (for example, if the adjacent lane object 250 starts an acceleration process and the vehicle 100 would have to carry out a post-acceleration using the drive motor 103 to adjust the target temporal distance 311). Furthermore, it is thus made possible to decelerate the vehicle 100 to the target distance 311 upon the coasting exit (without a post-acceleration to the target temporal distance 311 being required for this purpose).

The device 101 can therefore be configured to effectuate the coasting entry only from a specific plunging depth 312 of the predicted profile 310 (plunging below the target temporal distance 311 to the adjacent lane object 250).

The device 101 can furthermore be configured to ascertain an intersection 321 of the predicted coasting rollout curve 310 with the target temporal distance 311 to the adjacent lane object 250 for the exit from the coasting mode. The coasting exit can then take place before the target temporal distance 311 to the adjacent lane object 250 is reached (with a parameterizable offset value 322). The vehicle 100 can then be decelerated with a relatively light dynamic excess into the target temporal distance 311 (and shutdown and renewed acceleration are not necessary).

Therefore (by using the coasting mode), an efficient approach to an adjacent lane object 250, which is not permitted to be overtaken, for example, can be enabled. The approach can be carried out by decoupling of the internal combustion engine 103 and/or by assessing the gradient prediction and the driving resistances resulting therefrom.

For example, the vehicle 100 can drive on the center lane 221 on the freeway and can approach an adjacent lane object 250 on the left lane 222. The speed profile of the vehicle 100 and the distance profile 310 to the adjacent lane object 250 resulting therefrom can be predicted (for example, on the basis of the mapped gradient data). A coasting process of the vehicle 100 can then be triggered, so that the vehicle 100 efficiently approaches the adjacent lane object 250.

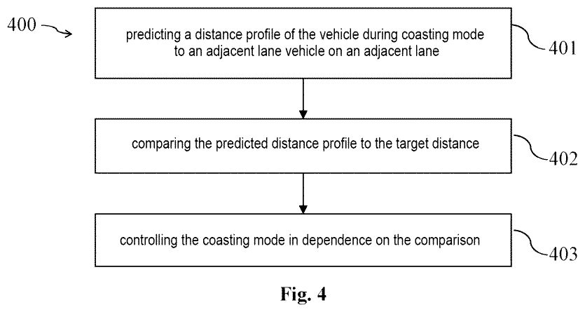

FIG. 4 shows a flow chart of a (possibly computer-implemented) method 400 for controlling the coasting mode of a (motor) vehicle 100 in the context of a distance and/or speed control of the vehicle 100 (in which the driving speed of the vehicle 100 is adjusted, in particular controlled, in dependence on a target distance 311 to a preceding vehicle 200 and/or to an adjacent lane object 250 and/or (during an open-road journey) in dependence on a target speed 411).

The method 400 comprises predicting 401, proceeding from a current driving progression 302 of the vehicle 100 (in particular proceeding from a current time and/or proceeding from a current position of the vehicle 100), a distance profile 310 of the vehicle 100 in the coasting mode. The distance profile 310 can be predicted on the basis of the profile 210 of the gradient 212 of the roadway 202 traveled by the vehicle 100. It can be assumed here that the vehicle 100 will be in the coasting mode over the entire predicted distance profile 310 (and therefore will not be driven by the drive motor 103 and/or therefore no drag torque will be caused by the drive motor 103). The distance profile 310 can indicate the actual distance 301 of the vehicle 100 to a preceding adjacent lane object 200 (on an adjacent lane 222).

The method 600 furthermore comprises comparing 402 the predicted distance profile 310 of the vehicle 100 to the target distance 311 of the distance control of the vehicle 100. It can be ascertained in particular here whether the predicted distance profile 310 of the vehicle 100 will reach and/or fall below the target distance 311 (within the prediction horizon for the predicted distance profile 310 of the vehicle 100).

The method 400 furthermore comprises controlling 403, in particular starting or ending, the coasting mode in dependence on the comparison. Due to the ascertainment and due to the evaluation of a predicted distance profile 310 of the distance 201, 301 to an adjacent lane object 200 during the execution of a distance and/or speed control, the comfort and the energy efficiency and/or the safety of the vehicle 100 can be increased. It can be enabled during the coasting mode that the actual distance 201, 301 and/or the actual driving speed temporarily deviate from the target distance 311 or from the target speed, respectively. The distance and/or speed control can therefore be interrupted during the coasting mode. Upon exiting from the coasting mode, the distance and/or speed control can then be automatically resumed.

The present invention is not restricted to the exemplary embodiments shown. In particular, it is to be noted that the description and the figures are only intended to illustrate the principle of the proposed methods, devices, and systems by way of example.

1.-11. (canceled)

12. A device for controlling a coasting mode of a vehicle in a context of a distance and/or speed control of the vehicle, wherein the device is configured to:
predict a distance profile of the vehicle in the coasting mode proceeding from a current driving progression of the vehicle, wherein the predicted distance profile indicates a temporal and/or spatial distance of the vehicle to an adjacent lane object driving in front of the vehicle on a neighboring lane as a function of the driving progression;
compare the predicted distance profile of the vehicle to a target distance of the distance and/or speed control of the vehicle; and
control the coasting mode in dependence on the comparison to start or end the coasting mode.

13. The device according to claim 12, wherein the device is configured, while the vehicle is not operated in the coasting mode, to:
determine whether the predicted distance profile of the vehicle will reach the target distance at an upcoming driving progression or not; and
start the coasting mode at the current driving progression of the vehicle only in a case in which a determination is made that the predicted distance profile of the vehicle will reach the target distance.

14. The device according to claim 12, wherein the device is configured, while the vehicle is operated in the coasting mode, to:
ascertain an upcoming intersection driving progression, at which the predicted distance profile of the vehicle will reach the target distance;
ascertain an exit driving progression in dependence on the ascertained upcoming intersection driving progression; and
end the coasting mode at the ascertained exit driving progression.

15. The device according to claim 13, wherein the device is configured, while the vehicle is operated in the coasting mode, to:
ascertain an upcoming intersection driving progression, at which the predicted distance profile of the vehicle will reach the target distance;
ascertain an exit driving progression in dependence on the ascertained upcoming intersection driving progression; and
end the coasting mode at the ascertained exit driving progression.

16. The device according to claim 14, wherein the device is configured to ascertain an exit driving progression, which lies at a predefined offset value before the ascertained upcoming intersection driving progression.

17. The device according to claim 15, wherein the device is configured to ascertain an exit driving progression, which lies at a predefined offset value before the ascertained upcoming intersection driving progression.

18. The device according to claim 12, wherein the device is configured, while the vehicle is not operated in the coasting mode, to:
ascertain whether the predicted distance profile falls below the target distance or below a predefined penetration depth of the target distance or not; and
start the coasting mode only in a case in which it is ascertained that the predicted distance profile falls below the target distance or below the predefined penetration depth.

19. The device according to claim 13, wherein the device is configured, while the vehicle is not operated in the coasting mode, to:
ascertain whether the predicted distance profile falls below the target distance or below a predefined penetration depth of the target distance or not; and
start the coasting mode only in a case in which it is ascertained that the predicted distance profile falls below the target distance or below the predefined penetration depth.

20. The device according to claim 12, wherein the device is configured to repeatedly, at a sequence of successive driving progressions:
predict a distance profile of the vehicle in the coasting mode proceeding from the respective current driving progression;
compare the predicted distance profile of the vehicle to the target distance of the distance and/or speed control of the vehicle; and
control to start or end the coasting mode at the respective current driving progression in dependence on the comparison.

21. The device according to claim 13, wherein the device is configured to repeatedly, at a sequence of successive driving progressions:
predict a distance profile of the vehicle in the coasting mode proceeding from the respective current driving progression;
compare the predicted distance profile of the vehicle to the target distance of the distance and/or speed control of the vehicle; and
control to start or end the coasting mode at the respective current driving progression in dependence on the comparison.

22. The device according to claim 12, wherein the device is configured to:
ascertain an upcoming gradient profile of a roadway traveled by the vehicle; and
predict the distance profile of the vehicle in the coasting mode based on the upcoming gradient profile.

23. The device according to claim 13, wherein the device is configured to:
ascertain an upcoming gradient profile of a roadway traveled by the vehicle; and
predict the distance profile of the vehicle in the coasting mode based on the upcoming gradient profile.

24. The device according to claim 12, wherein the device is configured to:
ascertain status data with respect to a status of the vehicle and/or with respect to a status of the adjacent lane object driving in front of the vehicle on the neighboring lane; and
predict the distance profile of the vehicle in the coasting mode based on the status data.

25. The device according to claim 13, wherein the device is configured to:
ascertain status data with respect to a status of the vehicle and/or with respect to a status of the adjacent lane object driving in front of the vehicle on the neighboring lane; and
predict the distance profile of the vehicle in the coasting mode based on the status data.

26. The device according to claim 12, wherein
the predicted distance profile extends proceeding from the current driving progression via a predefined prediction horizon; and/or
the driving progression comprises
a position of the vehicle along a roadway traveled by the vehicle; and/or
a time during a journey of the vehicle.

27. The device according to claim 13, wherein
the predicted distance profile extends proceeding from the current driving progression via a predefined prediction horizon; and/or
the driving progression comprises
a position of the vehicle along a roadway traveled by the vehicle; and/or
a time during a journey of the vehicle.

28. The device according to claim 12, wherein the device is configured to:
decouple a drive motor of the vehicle from a drivetrain of the vehicle in order to start the coasting mode; and/or
couple the drive motor with the drivetrain of the vehicle in order to end the coasting mode.

29. The device according to claim 13, wherein the device is configured to:
decouple a drive motor of the vehicle from a drivetrain of the vehicle in order to start the coasting mode; and/or
couple the drive motor with the drivetrain of the vehicle in order to end the coasting mode.

30. A method for controlling a coasting mode of a vehicle in a context of a distance and/or speed control of the vehicle, the method comprising:
predicting, proceeding from a current driving progression of the vehicle, a distance profile of the vehicle in the coasting mode, wherein the predicted distance profile indicates a temporal and/or spatial distance of the vehicle to an adjacent lane object driving in front of the vehicle on a neighboring lane as a function of the driving progression;
comparing the predicted distance profile of the vehicle to a target distance of the distance and/or speed control of the vehicle; and
controlling the vehicle to start or end the coasting mode in dependence on the comparison.
